(19) United States
(12) Patent Application Publication
(10) Pub. No.: US 2017/0083823 A1
(43) Pub. Date: Mar. 23, 2017

(54) Spectral Optimal Gridding: An Improved Multivariate Regression Analyses and Sampling Error Estimation

(71) Applicant: San Diego State University Research Foundation, San Diego, CA (US)

(72) Inventor: Samuel S.P. Shen, San Diego, CA (US)

(21) Appl. No.: 15/272,432

(22) Filed: Sep. 22, 2016

Related U.S. Application Data
(60) Provisional application No. 62/221,718, filed on Sep. 22, 2015.

(51) Int. Cl. G06N 7/00; G06N 5/02

(52) U.S. Cl. CPC G06N 7/005; G06N 5/02

(57) ABSTRACT

The invention is directed to computer implemented methods, systems, and devices for improving a reconstruction model, e.g. historical precipitation reconstruction model for a given region, by applying a standard multivariate regression analysis to the reconstruction model to obtain a truncated sampling error variance from sampling the first set of empirical orthogonal functions, wherein the reconstruction model is improved when the reconstruction is combined with the quantified minimum sampling error.

### FIELD OF THE INVENTION

The invention relates to improvements in spatial predictive models, and particularly to the use of a computer implemented multivariate regression procedure to improve the estimation of sampling errors in spatial data reconstruction.

### BACKGROUND

Quantifying uncertainties in a poorly sampled field is important in the development of accurate models of spatial prediction. Finding reliable reconstructions for historical, observed datasets, such as global precipitation, is of critical importance to both change assessment and model validation. Reconstruction errors can either be sampling errors, bias errors, or random errors. Currently, there remains a need to address the uncertainties in various kinds of observations and to improve accuracy of very large-scale reconstructions.

### SUMMARY

Accordingly, in order to address such needs, we have provided a method of improving a reconstruction, comprising the steps of: (i) expanding a field of observed historical gridded data into a finite series of empirical orthogonal functions (EOFs); (ii) using a multivariate regression algorithm to determine the optimal coefficients of EOFs; (iii) screening each EOF and eliminating any EOF not supported by the observed historical data; (iv) generating a reconstruction model from the screened, weighted empirical orthogonal functions; and (v) applying multivariate regression error analysis and statistical inference tools to obtain a truncated sampling error variance from sampling the first N, say 20, EOFs, wherein the reconstruction accuracy is improved and the corresponding sampling error variance is to quantify the uncertainties in reconstruction and observations.

In preferred embodiments, the method is used to provide models for predicting global precipitation changes on an annual basis. In alternate preferred embodiments, the method is used to provide meteorological models for forecasting weather; a radiological imaging models for improving medical imaging; a weather history time machine that animates the past climate back to 1851; a virtual reality climate model of a gaming environment to make gaming milieu more realistic; a seismic signal reconstruction model for oil recovery processes; a calibration model for satellite remote sensing signals; a model of chemical processes for producing industrial chemicals; a model of bioreactor processes for producing biologics; a model for analyzing telecommunications signals for planning networks; a model for tracking social media data for advertising and marketing purposes; a microclimate model for controlling an HVAC (heating, ventilating, and air conditioning) system; a model of environmental pollution assessment using limited monitoring stations; a model of image reconstruction for historical pictures and films; a model of big data applications for signal recovery; and a model of drug discovery using data mining method.

In a further preferred embodiment, the meteorological model for recovering historical data comprises climate parameters selected from the group consisting of temperature, precipitation, ocean salinity, atmospheric pressure, atmospheric humidity, and wind speed.

In another preferred embodiment, the model for analyzing telecommunication signals further comprises the step of site-planning network and microwave towers.

In another preferred embodiment, there is provided a method of improving a reconstruction model, comprising the steps of: (i) expanding a field of observed historical gridded data into a finite series of empirical orthogonal functions (EOFs), (ii) using multivariate regression method to determine expansion coefficients of the EOFs; (iii) screening each EOF and eliminating EOFs not supported by observed historical data; (iv) generating a reconstruction model from the screened, weighted EOFs according to the following formula:

R(x, t)=R(x, t)+e(x, t) (1)

where

$$\hat{R} ( x , t ) = {\sum }_{m ∈ ℳ} {β}_{m} ( t ) {ψ}_{m} ( x ) = {\sum }_{m ∈ ℳ} {β}_{m} ( t ) {E}_{m} ( x ) / \sqrt{a ( x )} \qquad ( 2 )$$

wherein x denotes a first parameter of the gridded data on a grid having N boxes and hence x runs from 1 to N;

wherein a(x) is a relative geometric factor determined by geometric shape of the reconstruction domain, and is a(x)=cos(φₓ) the cosine of the latitude for the location index x;

wherein M is the set of selected EOF modes;

wherein Eₘ(x) denotes the mth EOF computed from a weighted covariance matrix of the recently observed, complete, gridded data and the Euclidean norm of Eₘ(x) is one;

wherein ψₘ(x)=Eₘ(x)/\sqrt{a(x)} is an eigenfunction of an integral operator from a kernel of the unweighted covariance function;

wherein t denotes time;

wherein βₘ(t) is an estimated EOF weight or regression coefficient for the mth EOF;

wherein R(x, t) is the reconstruction model; and,

(v) applying a standard regression analysis to the reconstruction model to obtain a truncated sampling error variance from sampling the first 20 EOFs, wherein the reconstruction model is improved, has the best accuracy up to date and has an estimate of the truncated sampling error variance.

In another preferred embodiment, there is provided wherein the first parameter is temperature, the second parameter is a geographic location parameter, and the model is a model for climate change.

In another preferred embodiment, there is provided one or more improved reconstruction models configured to perform any of the methods herein.

In another preferred embodiment, there is provided a system for utilizing an improved reconstruction model, comprising: a model as disclosed herein; and a computer having a processor, a memory, an input device, an output device, a computer bus, a power supply, an operating system and device-executable instructions for performing any of the methods disclosed herein.

In another preferred embodiment, there is provided a computer-readable media storing a computer program on one or more device memories, the computer program comprising device-executable instructions for performing any of the methods disclosed herein.

### BRIEF DESCRIPTION OF THE FIGURES

FIG. 1 shows the July 1917-June 1918 snapshot of an animation of the Annual Mean Precipitation Anomalies [mm/day] from 1900-current.

### DETAILED DESCRIPTION OF THE INVENTION

The present invention focuses on the sampling errors in the reconstruction method of Smith et al. (1996, 2008b). The approach is to formulate the Smith method into a multivariate regression procedure so that the existing statistical inference results can be used on errors such as confidence interval (CI), sum of squared errors (SSE), and root-mean-square errors (RMSE). This approach has other advantages too, such as allowing simplified comparisons against other regression models and checking the model's fit for the given, e.g. climate, parameter. The inventive has simplified Smith reconstruction procedure and facilitates systematic studies of reconstructions and their error estimations for various applications including reconstruction of communication signals, MRI and CT signals, seismic signals in oil recovery, and spatiotemporal EEG signals for medicine.

Aside from developing new, more accurate reconstruction results, this uncertainty quantification method differs from the error estimation work of Smith et al. (2013) in four main aspects for the precipitation reconstruction applications: (i) we build our construct based on the existing multivariate regression; (ii) we estimate the confidence interval of regression coefficients; (iii) we examine the regression error variance over the data domain; and (iv) we provide some expanded discussions of physical mechanisms, such as El Niño-Southern Oscillation (ENSO) patterns that contribute to the reconstruction skills.

Computer System Features

As described herein, the methods of the present invention necessarily contemplate the use of computer systems to gather data, store data, process the reconstructions, perform the multivariate regression procedures, generate desired outputs, and display various aspects of the models developed using the invention.

The spectral optimal gridding (SOG) invention is also a computing system that includes a logic subsystem, a data-holding subsystem, a display subsystem, and/or a capture device. The computing system may optionally include peripheral components that are not integrated into the computing system. Logic subsystem may include one or more physical or virtual devices configured to execute one or more instructions. For example, the logic subsystem may be configured to execute one or more instructions that are part of one or more programs, routines, objects, components, data structures, or other logical constructs. Such instructions may be implemented to perform a task, such as the SOG core computing of matrix inversion and multiplications for multivariate regression, implement a data type, transform the state of one or more devices, or otherwise arrive at a desired result. The logic subsystem may include one or more processors (CPUs) that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Data-holding subsystem, or memory, may include one or more physical or virtual devices configured to hold data and/or instructions executable by the logic subsystem to implement the herein described methods and processes. When such methods and processes are implemented for extremely high dimension and extremely large datasets due to a large number of samples and variables, the state of data-holding subsystem may be transformed (e.g., to hold different data). Data-holding subsystem may include removable media and/or built-in devices. Data-holding subsystem may include optical memory devices, semiconductor memory devices (e.g., RAM, EEPROM, flash, etc.), and/or magnetic memory devices, among others. Data-holding subsystem may include devices with one or more of the following characteristics: volatile, nonvolatile, dynamic, static, read/write, read-only, random access, sequential access, location addressable, file addressable, and content addressable. In some embodiments, logic subsystem and data-holding subsystem may be integrated into one or more common devices, such as an application specific integrated circuit or a system on a chip.

The data-holding subsystem may also use or incorporate computer-readable removable media, which may be used to store and/or transfer data and/or instructions executable to implement the herein described methods and processes.

A display subsystem may be used to present a visual representation of data held by data-holding subsystem. As the herein described methods and processes change the data held by the data-holding subsystem, and thus transform the state of the data-holding subsystem, the state of display subsystem may likewise be transformed to visually represent variations and evolutions in the underlying data of multivariate. The display subsystem includes graphics, animations and digital data processing capability either by the logic subsystem, a dedicated graphics processing subsystem, or combination of the two.

Display devices for reading include handheld devices such as cell phones, PDAs, electronic book readers such as the Kindle Fire, tablet computers, mini tablet computers, laptop computers, desktop computers and wearable computing devices. As a nonlimiting example, the display may be a touch screen display within a touch screen O/S environment or utilizes an existing hardware controller/button of the particular device. Such display devices may be combined with logic subsystem and/or data-holding subsystem in a shared enclosure, or such display devices may be peripheral display devices, as are known in the art. As with all contemplated devices, certain hardware and software systems are required, as would be known to a person of ordinary skill in the computer arts.

It is contemplated that a device and method will utilize various telecommunications technologies for connectivity to a document being read, including communications interfaces, transceivers and protocols necessary for IP4, IP6, WiFi 802.11 a/b/g/n, Bluetooth, GSM networks including EDGE and LTE, CDMA networks including EV-DO and LTE.

The devices and methods also include network implementations including client-server architectures. Servers may include server entities that access, fetch, aggregate, process, search, and/or maintain documents in a manner consistent with the principles of the invention. Clients and servers may connect to network via wired, wireless, and/or optical connections, and cloud computing setup when dealing with extremely large datasets.

Networks may include one or more networks of any type, including a local area network (LAN), a wide area network (WAN), a metropolitan area network (MAN), a telephone network, such as the Public Switched Telephone Network (PSTN) or a Public Land Mobile Network (PLMN), an intranet, the Internet, a memory device, or a combination of networks. The PLMN(s) may further include a packet-switched sub-network, such as, for example, General Packet Radio Service (GPRS), Cellular Digital Packet Data (CDPD), or Mobile IP sub-network. While servers may be as separate entities, it may be possible for one or more of the functions to be shared amongst servers. For example, it may be possible that multiple servers are implemented as a single server. The client/server entity may perform these operations in response to processor executing software instructions contained in a computer-readable medium, such as memory. A computer-readable medium may be defined as a physical or logical memory device and/or carrier wave.

The software instructions may be read into memory from another computer-readable medium, such as data storage device, or from another device via communication interface. The software instructions contained in memory cause processor to perform operations or processes to effectuate the goals of the invention. Alternatively, hardwired circuitry may be used in place of or in combination with software instructions to implement processes consistent with the principles of the invention. Thus, implementations consistent with the principles of the invention are not limited to any specific combination of hardware circuitry and software.

Sampling Errors of the Reconstruction

Similar to Eq. (22) of Shen et al. (2004), the area weighted mean square error field of the reconstruction due to sampling gaps can be derived as

$$\begin{matrix}{ɛ}_{a}^{2} ( x , t ) = 〈 {[ R ( x , t ) \sqrt{a ( x )} - 〈 \hat{R} ( x , t ) \sqrt{a ( x )} 〉 ]}^{2} 〉 \\ = {ɛ}_{M}^{2} ( x , t ) + {ɛ}_{R}^{2} ( x , t ) .\end{matrix} \qquad \begin{matrix}( 25 ) \\ ( 25 )\end{matrix}$$

The first term on the right-hand side accounts for the truncated sampling error from sampling the first M EOF modes, while the second term accounts for the random data error in the reconstruction. According to Shen et al. (1994, 2004), the truncated error field is

$${ɛ}_{M}^{2} ( x , t ) = {\sum }_{m ∈ ℳ} {ɛ}_{m}^{2} ( t ) {E}_{m}^{2} ( x ) . \qquad \begin{matrix}( 26 ) \\ ( 26 )\end{matrix}$$

Equation (26) is a truncated sampling error variance. The total error variance that reflects the overall uncertainty should consist of this truncated sampling error, random truncation error, and bias errors. Smith et al. (2013) discussed the structure of these different errors and their relative importance. The current paper focuses on the detailed mathematics of the truncated sampling errors.

For every selected mode in M, the coefficient ε²ₘ(t)

can be calculated by the following formula:

$$\begin{matrix}{ɛ}_{m}^{2} ( t ) = {\sum }_{n ∈ ℳ} {{λ}_{n} [ {δ}_{mn} - {\sum }_{x ∈ {Ω}_{d}} {E}_{n} ( x ) {G}_{m} ( x ) ]}^{2} + \\ {\sum }_{x ∈ {Ω}_{d}} 〈 {e}_{x}^{2} 〉 {a ( x ) [ {G}_{m} ( x ) ]}^{2} ,\end{matrix} \qquad \begin{matrix}( 27 ) \\ ( 27 )\end{matrix}$$

where

δₘₙ is the Kroneker delta, which is equal to one if m=n and equal to zero otherwise;

[symbol] eₓ² [symbol] is the variance of the observed error for data D(x, t); and

Gₘ(x) is the mth column and the xth row of the G=(Z′_{d}Z_{d})⁻¹Z′_{d} matrix.

For each given time t, this formula and eq. (26) calculates the sampling error variance map of the reconstruction.

The Smith Reconstruction Method

Smith et al. (1996) introduced a reconstruction method for sea surface temperature (SST) using EOFs. They expanded the SST field into a finite series of EOFs and used the least squares method to determine the EOF coefficients or weights of the EOFs. Hence, it is a regression procedure. To determine which EOF modes should be included in the series expansion, Smith et al. (1998) introduced a screening procedure that determined whether a particular EOF was properly sampled by the observed data. This is basically a screening regression method. The Smith reconstruction method has been successfully used to reconstruct both SST (Smith and Reynolds 2005; Smith et al. 2008a) and precipitation (Smith et al. 2008b, 2012).

Below, we explain the Smith reconstruction theory and then we apply a regression analysis to describe the error bounds of the regression reconstruction.

The Smith reconstruction model is

R(x, t)=R(x, t)+e(x, t), (1)

(1)

where

$$\hat{R} ( x , t ) = {\sum }_{m ∈ ℳ} {β}_{m} ( t ) {ψ}_{m} ( x ) = {\sum }_{m ∈ ℳ} {β}_{m} ( t ) {E}_{m} ( x ) / \sqrt{a ( x )} \qquad \begin{matrix}( 2 ) \\ ( 2 )\end{matrix}$$

is the reconstruction and

e(x, t)·N[0, ε²(x, t)] for x=1, 2, . . . N (3)

(3)

is the reconstruction error and is assumed to be normally distributed for each grid box x.

Here, x denotes the location of the N grid boxes and hence x runs from 1 to N; a(x)=cos(φₓ) is the relative-area factor and is equal to the cosine of the latitude of the centroid of the grid box x; and M is the set of selected EOF modes and has an order M. The term Eₘ(x) denotes the mth EOF computed from the area-weighted covariance matrix of annual GPCP precipitation anomaly data and the Euclidean norm of Eₘ(x) is one because of the inclusion of the area factor, while ψₘ(x)=Eₘ(x)/\sqrt{a(x)}

is the physical EOF that is an eigenfunction of the integral operator from the kernel of precipitation covariance function without area factor;

t denotes time;

βₘ(t) is the EOF weight or regression coefficient for the mth EOF and is to be estimated;

R(x, t) is the unknown precipitation field to be reconstructed based on the estimation of βₘ(t) ; the regression error variance,

ε²(x, t)= [symbol] e²(x, t) [symbol] (4)

(4)

is to be estimated; and the angle brackets denotes the operation of expected value. The domain of the reconstruction field is denoted by Ω, which is fixed. The observed monthly gridded GHCN anomaly data on 5°×5° grid boxes are distributed across a subset of the domain. This subset is denoted by Ω_{d} ,which varies with time, since the sample stations and satellites change over time. The orders of Ω, Ω_{d} and M are denoted by

∥Ω∥=N, ∥Ω_{d}∥=N_{d}, ∥ [symbol] ∥=M. (5)

(5)

The observed data are denoted by

D(x, t), x ∈ Ω_{d}. (6)

(6)

The sum of squared errors (SSE) over the spherical geometry is

$$SSE = {\sum }_{x ∈ {Ω}_{d}} {[ D ( x , t ) - \hat{R} ( x , t ) ]}^{2} a ( x ) . \qquad \begin{matrix}( 7 ) \\ ( 7 )\end{matrix}$$

The SSE formula can be rewritten into

$$SSE = {\sum }_{x ∈ {Ω}_{d}} {[ D ( x , t ) \sqrt{a ( x )} - \hat{R} ( x , t ) \sqrt{a ( x )} ]}^{2} . \qquad \begin{matrix}( 7 a ) \\ ( 7 a )\end{matrix}$$

Then, the standard least squares estimate formulas can be applied to the area-weighted data R(x, t) \sqrt{a(x)}(Johnson and Wichern 2007; Wilks 2006).

To use the standard multivariate regression framework, we introduce the following notations:
(i) explainable variables' matrix of N rows (x=1, 2, . . . , N) and M columns for the MEOF modes (m=1, 2, . . . , M),

Z=[Eₘ(x)]_{N×M}; (8)

(8)

(ii) explainable variable's data matrix of N_{d} rows (x_{d}=1, 2, . . . , N_{d}) and M columns for the MEOF modes (m=1, 2, . . . , M),

Z_{d}=[Eₘ(x_{d})]_{N}_{_{d}}_{×M}, (9)

(9)

which is a submatrix of Z=[Eₘ(x)]_{N×M}, by retaining only N_{d} rows in Z;

(iii) area-factor-weighted response variable's data vector of dimension N_{d} for a given time t (yr),

y_{d}=[D(x_{d}, t)\sqrt{a(x_{d})}]_{N}_{_{d×}}₁; (10)

(10)

(iv) estimator vector of the regression coefficients: that is, EOF mode coefficients βₘ(t) of dimension M,

b=[bₘ(t)]_{M×1}, (11)

(11)

where the estimators bₘ(t) (m=1, 2, . . . , M) are deterministic variables with respect to time, while EOF modes' coefficients βₘ(t) (m=1, 2, . . . , M) are random variables;

(v) M×M square matrix, which will be used for calculating the regression coefficients,

B=Z′_{d}Z_{d}, (12)

(12)

where Z′ stands for the transposed matrix of Z;

(vi) the unknown vector that will be interpolated,

Y(t)=[R(x, t)\sqrt{a(x)}]_{N×1}; and (13)

(13)

and

(vii) the area-weighted regression residual vector,

εₐ=[e(x, t)\sqrt{a(x)}]_{N×1}; (14)

(14)

Thus, the vector form of the regression model [Eq. (1)] can be written as

Y(t)=Zβ+εₐ. (15)

(15)

The least squares linear regression formula that minimizes SSE [see chapter 7 of Johnson and Wichern (2007)] leads to an estimator for the regression coefficients,

b=B⁻¹Z′_{d}y_{d}=Gy_{d} (16)

(16)

where b is the unbiased estimator of β and

G=B⁻¹Z′_{d} (17)

(17)

is the link matrix of M×N_{d} order that links the GHCN data and the EOF mode weights.

The expected value (i.e., the ensemble mean) of Zβ is Zb;

ŷ(t)=[\hat{R}(x, t)\sqrt{a(x)}]_{N×1}=Hy_{d}=Z(Z′_{d}Z_{d})⁻¹Z′_{d}y_{d} (18)

(18)

is the reconstructed precipitation vector and is an approximation to the area-weighted data y_{d}(t) over the entire domain Ω. The rectangular N×N_{d} H matrix,

H=Z(Z′_{d}Z_{d})⁻¹Z′_{d}, (19)

(19)

is called the “hat matrix” in statistics. The hat matrix is a link between the observed data over the data domain Ωd and the reconstruction over the entire domain Ω.

The approximation error vector restricted to the data domain is denoted by

\hat{ε}_{d}(x=x_{d},t)=(y_{d}−ŷ_{d})(x=x_{d},t)/\sqrt{a(x)} (20)

(20)

and is an N_{d}×1 vector) (x_{d}∈Ω_{d}). According to the multivariate regression theory (Johnson and Wichern 2007), the regression error variance σ², after eliminating

the area factor, can be estimated by SSE which is defined by Eq. (7):

$${\hat{σ}}^{2} = \frac{{‖ {\hat{ɛ}}_{d} ‖}^{2}}{{N}_{d} - M - 1} , \qquad \begin{matrix}( 21 ) \\ ( 21 )\end{matrix}$$

where ∥\hat{ε}_{d}∥ is the regular Euclidean norm by

$${‖ {\hat{ɛ}}_{d} ‖}^{2} = {\sum }_{x ∈ {Ω}_{d}} {[ {\hat{ɛ}}_{d} ( x ) ]}^{2} . \qquad \begin{matrix}( 22 ) \\ ( 22 )\end{matrix}$$

Equation (21) implies that the error variance of regression is inversely proportional to the number of data boxes: More data imply less error variance, but more modes may mean larger error variance; that is, a larger M may imply a larger \hat{σ}². This is because higher modes may include much noise. In practice, we usually choose M so that 90% of the variance is explained by the first MEOF modes. It seems difficult to find an optimal number of modes to be retained (Shen et al. 2001). The CI at 95% confidence level for βₘ in Eq. (2), based on the t distribution of N_{d}−M degrees of freedom, is

$${b}_{m} \pm {t}_{{N}_{d} - M} ( \frac{0.95}{2} ) \sqrt{var ( {β}_{m} )} , \qquad \begin{matrix}( 23 ) \\ ( 23 )\end{matrix}$$

where

$$var ( {β}_{m} ) = {diag}_{m} [ \frac{{N}_{d} {\hat{σ}}^{2}}{{N}_{d} - M} {( {Z}_{d}^{′} {Z}_{d} )}^{- 1} ] . \qquad \begin{matrix}( 24 ) \\ ( 24 )\end{matrix}$$

In the above, t _{Nd-M}(0:95/2) is the t value of a t distribution with degrees of freedom equal to N_{d}−M and the tail probability equal to 0.95/2, and diagₘ indicates the mth diagonal element of a square matrix (Johnson and Wichern 2007, p. 372).

The CI of regression coefficients implies that the reconstruction by Eq. (18) is the expected value of a family of reconstructions, determined by the CI of bₘ, m=1, 2, . . . , M. Hence, a range of the reconstructed field can be determined and may be regarded as a spread of true precipitation fields.

Example of Reconstruction—Climate Change Model

Current Problem—Discrepancy

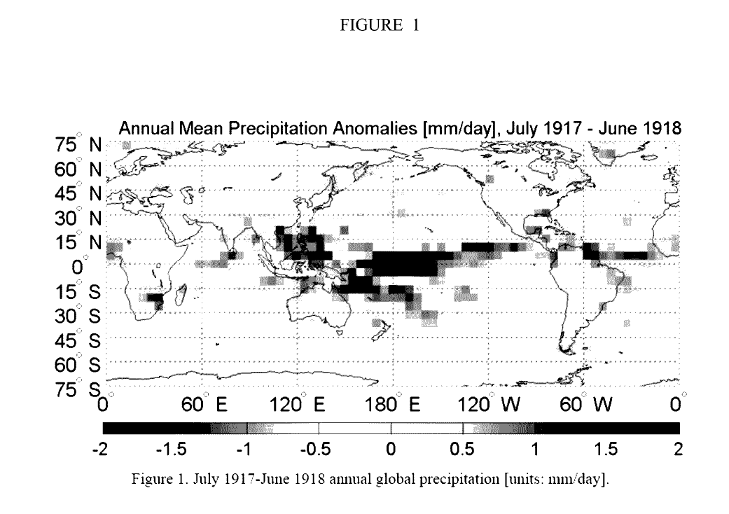

A systematic discrepancy exists in the global-average annual-mean precipitation between reconstruction observations (about 2.66 mm day⁻¹) and models from phase 5 of the Coupled Model Intercomparison Project (CMIP5) (about 2.96 mm day⁻¹; Arkin et al. 2010; Ren et al. 2013; Bosilovich et al. 2008). Compared to the reconstructed observation (FIG. 1), the CMIP5 model mean systematically overestimates the global precipitation. Other model means include 2.85 mm day⁻¹ from the 24 CMIP3 models, 3.36 mm day⁻¹ from the Climate Variability and Predictability (CLIVAR) International Climate of the Twentieth Century Project (C20C), and 2.93 mm day⁻¹ from the National Centers for Environmental Prediction's (NCEP) Reanalysis-1, while the Global Precipitation Climatology Project (GPCP; Adler et al. 2003) and the Climate Prediction Center's (CPC)Merged Analysis of Precipitation (CMAP; Xie and Arkin 1997) observations since 1979 agree with the reconstruction and are all about 2.65-2.67 mm day⁻¹. This systematic discrepancy involves a combination of uncertainties in the modeling of complex precipitation processes and the uncertainties in merging inhomogeneous and diverse measurements and estimates of precipitation into global precipitation datasets.

A Solution

In one exemplary embodiment, we provide herein a multivariate regression approach to estimate the sampling errors of annual quasi-global precipitation reconstructed by EOF expansion. The mathematical details of the error analysis approach are a distinct feature of this invention, and hence help reduce the reconstruction error and increase the reconstruction accuracy.

Source of Computer Program

Spectral Optimal Gridding of Precipitation Matlab toolkit, Version 1.0 (SOGP 1.0) is designed to reconstruct the annual or monthly precipitation anomalies [units: mm/day] for the entire globe, except the polar regions south of 75° S and north of 75° N. The reconstructed area is 96% of the entire Earth. The output's spatial-temporal coverage is flexible according to users' needs and is determined by the following spatial-temporal box: [lat1, lat2] X [lon1, lon2] X [time1, time2]. The latitude band [lat1, lat2] must be within [75° S, 75° N]. The longitude range must be in [0, 360]. The temporal range is limited to [1900, 2011], which will be updated to [1850, present] according to the availability of the Global Historic Climatology Network (GHCN) data. The program is based on the mathematical theory outlined in the paper of Shen, S. S. P., N. Tafolla, T. M. Smith, and P. A. Arkin, 2014: Multivariate regression reconstruction and its sampling error for the quasi-global annual precipitation from 1900-2011,1 J. Atmospheric Sciences, 71, 3250-3268. doi: 10.1175/JAS-D-13-0301.1. The Shen et al. paper also describes the use of multivariate regression to reconstruct the gridded data by using the Global Precipitation Climatology Project (GPCP) from 1979-2008 data to compute the EOF basis and the gridded GHCN from 1900 as the data for the response variable in the regression. The User Manual of SOGP Version 1.0: A User-Friendly Friendly MatLab Program for Reconstructing Global Precipitation contains detailed instructions how to use SOGP 1.0 and is provided to the user together with the software.

MATLAB (matrix laboratory) is a multi-paradigm numerical computing environment and fourth-generation programming language developed by MathWorks. MATLAB allows matrix manipulations, plotting of functions and data, implementation of algorithms, creation of user interfaces, and interfacing with programs written in other languages, including C, C++, Java, Fortran and Python.

MATLAB tookkits are version numbered starting with 1.0 in 1984, and include up to MATLAB 8.5 in Mar. 2015.

Free open source alternatives to MATLAB, in particular GNU Octave, Scilab, FreeMat, Julia, and Sage which are intended to be mostly compatible with the MATLAB language.

Empirical Orthogonal (EOFs)

EOFs are the pattern or vector that can be used to explain past data using as few predictors as possible. EOF analysis determines a set of orthogonal functions that characterizes the covariability of a data series, e.g. time series, for a set of grid points in a simple way. Thus by allowing a user to refer to X EOF patterns with N values in time rather than X grid points each with N values in time, the data is more compactly characterized. In practice, EOF patterns taken from data-rich periods allows estimation of values into data-poor periods; knowing variability in one region allows estimation in a related region.

In systems having highly complex interactions between many degrees of freedom or between many modes, EOFs decompose fields into a pattern and an associated index. This allows EOfs to reduce a large number of variables in the original data to just a few variables without compromising the variability of the data.

Source of Data

The Global Precipitation Climatology Project (GPCP) precipitation data from 1979 to 2008 are used to calculate the EOFs.

The database used for the example provided herein currently contains the following data:
Reconstruction data: Excel table of the reconstructed annual precipitation since 1900 aggregated from January to December, February—January, March—February, . . . , December—November.
(ii) Reconstruction figures: JPEG figures for each year, according to the above 12 kinds of annual data aggregation methods.
(iii) Empirical orthogonal functions (EOFs): Data Excel and JPEG files based on the GPCP data of 1979-2008 for the 12 kinds of annual data aggregation.
(iv) Principal Components (PCs): Includes PCs of the corresponding EOFs.
(v) Reconstruction coefficients: Regression reconstruction coefficients of all the included EOF modes.
(vi) Global average annual precipitation time series: Data in Excel and JPEG figures.
(vii) Error data for uncertainty: Root mean square error (RMSE) Excel data for every annual reconstruction.
(viii) Climatology: GPCP precipitation climatology for the base period of 1979-2008, based on each of the 12 ways of annual data aggregation.

Source of Regression Coefficients

The Global Historical Climatology Network (GHCN) gridded data (1900-2011) are used

to calculate regression coefficients for reconstructions. The sampling errors of the reconstructions are carefully analyzed using multivariate regression theory. Our reconstructed time series of quasi-global-average annual precipitation shows a 0.024 mm day⁻¹ (100 yr)⁻¹ trend, which is very close to the trend derived from the mean of 25 models of phase 5 of the Coupled Model Intercomparison Project.

Referring now to FIG. 1, a snapshot of an animation of the Annual Mean Precipitation Anomalies [mm/day] from July 1917 to June 1918 is shown. This snapshot references an animation of the global annual precipitation from 1900, based on the optimal reconstruction paper of Shen et al. (2014) and the spectral optimal gridding of precipitation Matlab toolkit, Version 1.0 (SOGP 1.0). The current animation downloaded from this open access is the annual data aggregated from July to June of next year. The spatial resolution is 5° latitude-longitude, covering from 75° S to 75° N. The frame of the July 1917-June 1918 annual global precipitation, a strong La Nina episode, is shown.

Our reconstruction examples of 1983 El Niño and 1917 La Niña precipitation patterns demonstrate that the El Niño and La Niña precipitation is well reflected in the first two EOFs. Although our validation in the GPCP period shows remarkable skill to predict oceanic precipitation from land stations, our error pattern analysis through comparison of the reconstruction and GHCN suggests the critical importance of improving tropical oceanic measurement of precipitation. This is because the tropical oceanic precipitation has both large mean and large variance. The validation of our reconstruction results with GPCP makes it possible to use the reconstruction as the benchmark data for climate models. This will help the climate modeling community to improve model precipitation mechanisms and reduce the systematic difference between observed global precipitation, which hovers at around 2.7 mm day⁻¹ for reconstructions and GPCP, and model precipitation, which has a range of 2.6-3.3 mm day⁻¹ for CMIP5.

When using EOFs, there is always a question of how many EOF modes to retain. This is an issue of model fit (Shen et al. 2001). Akaike's information criterion (AIC) might be useful in addressing this question, since the AIC method can help select an optimal number of empirical orthogonal functions (Michaelis 2013). One preferred AIC formula contemplated herein is provided:

AIC=2k−2ln(L),

where L is the maximized value of the likelihood function for the model, and k is the number of estimated parameters in the model.

When n, the sample size, is small or k, the number of parameters, is large, another preferred AIC formula is:

AICc=AIC+(2k(k+1)/n−k−1)

Running SOGP

Running SOGP requires that users have Matlab on their computers. Matlab Plotting toolbox is also required to correctly view the global precipitation maps.

To begin, place SOGP V1.0 in a folder named SOGPrecip. Double click to open the Matlab file, mainDriver.m. A Matlab window will open to allow you to enter the following parameters:
basePeriod
(ii) monthRange
(iii) miniMonthsThreshold
(iv) LatLimit
(v) LonLimit
(vi) numModes and
(vii) ReconstructionYears.

Their default values are already in the program and appear below:
basePeriod=[1979 2008]; GPCP base period for GPCP climatology.
(ii) monthRange=[1 12]; Indicates how the annual data are aggregated, [1 12] means Jan-Dec, and [7 6] means July to next June. This can also be seasonal, such as [6 8] for June-August summer.
(iii) miniMonthsThreshold=6; Indicates minimum number of months of GHCN data needed for the annual data to be included in the SOGP calculation. If it is for seasonal reconstruction, then this number must be less than or equal to 3.
(iv) LatLimit=[−75 75]; Latitude range. This can be changed to any interval within [−75 75], e.g. [0 20].
(v) LonLimit=[0 360]; Longitude range. This can be changed to any interval in [0 360], e.g. [10 90].
(vi) numModes=20; Number of EOF modes used in reconstruction. The max is 30 and min may be 10.
(vii) ReconstructionYears=1900:2011; Desired years of reconstruction, e.g. 1931:1960.

The desired parameters within the default intervals are then entered according to need. The EOFs and the reconstructions are still computed for the default parameters. Only the output will be made for the specified spatial-temporal domain. Once the desired parameters have been entered, the Run button from the top of Matlab's tool bar is clicked to start running the program. When running for the first time, it may take a few minutes for results to appear. When the program has finished running, four figures will appear. The first is the reconstruction for a specified time, the second is the corresponding reconstruction's root mean square error (RMSE), the third is the area-weighted average of the precipitation over the specified spatial region, and the fourth is the EOF 1 pattern. The figure of EOF 1 pattern will then appear. MATLAB can then be manipulated to provide reports and headings according to the user's need.

Additional SOGP Output Results

Once desired parameter values are entered, the program outputs not only the reconstruction, but also other statistics, for the purposes of validating calculations and demonstrating climate physics.

EOF calculations: The program calculates the covariance matrix from the GPCP data, its eigenvalues (sorted from largest to smallest), and the corresponding EOF vectors. The first EOF pattern is plotted. A user can export the 30 eigenvalues and 30 EOF vectors into an Excel table and produce figures of a desired EOF and a desired reconstruction year, by placing the desired number corresponding to the column space of graphing function plotdata (Matrix(:,desired number) . . . ). For example, if ReconstructionYears is 1902:1907 and the user desires to plot the precipitation pattern of 1905, they would enter 3 into the “desired number” place−plotdata(Recon(:,3), newLat, newLon). To plot the second EOF, they would enter plotdata (EOF (: , 2) , lat, ion).

Reconstructed data: The reconstruction procedure outputs the reconstructed data, which are exported to an Excel file and saved in a prescribed file folder (the default is the downloaded software folder or the Results folder in the SOGPrecip folder). Each column of the Excel table is the data for a year, while the location identities are arranged in rows. Their order is from furthest south latitudinal coordinates to furthest north, all corresponding to the westernmost longitudinal coordinate; this format is repeated until the easternmost longitudinal coordinate is reached. The first column is the latitude and the second the longitude, while the first row is the year.

RSME sampling errors: SOGP V1.0 also outputs sampling errors due to spatial gaps of sampling stations. The RMSE data are exported to an Excel file, which are in the same format as the reconstructed precipitation: Columns for time and rows for the grid boxes' spatial locations.

Time series of the global average: The global average is computed by the area-weighted method and is outputted into an Excel file. The first column lists the years, and the second column, the time series of the global averages. The time series is plotted with the years (the first column) as the x values and the global averages as the y values.

Animation of the reconstructed global precipitation anomalies: The spatial pattern of precipitation for each year forms a frame and is animated for an entire reconstruction period, such as from 1900-2011. These figures are automatically saved to an animations file folder within the downloaded program file and will close automatically when the animation program finishes running.

Example of Alternate Reconstructions

Example—Meteorological-Environmental-Virtual Climate Model

In this example for recovering historical data of various climate parameters, such as temperature, precipitation, ocean salinity, atmospheric pressure, atmospheric humidity, and wind speed, or for environmental pollution assessment using limited monitoring stations, or for a microclimate model for controlling an HVAC system, or for virtual reality climate model of a gaming environment for making gaming milieu more realistic, there is a computer implemented method for improving a reconstruction model, comprising the steps of: (i) computing, with a processor, a plurality of empirical orthogonal functions (EOFs) by expanding set of observed historical climate related gridded data into a finite series of the empirical orthogonal functions; (ii) displaying on a graphical user interface a covariance matrix of the observed historical climate related gridded data set, eigenvalues of the observed historical climate related gridded data set sorted from largest to smallest, and corresponding EOF vectors from the observed historical climate related gridded data set; (iii) performing multivariate regression on the EOFs using the processor to determine weight coefficients of the EOFs; (iv) screening each of the plurality of EOFs and eliminating any EOF not supported by the first data set of observed historical climate related gridded data; (v) generating a reconstruction model from the screened, weighted EOFs according to the following Reconstruction Model formula provided herein and, (vi) applying a multivariate regression error analysis to the reconstruction model to obtain a truncated sampling error variance from sampling the first N EOFs where N is between 10 and 30, wherein the reconstruction model is improved when combined with the truncated sampling error variance.

Example—Imaging-Signal Processing Model

In this example for recovering historical imaging or signal processing data of various models for improving medical imaging, seismic signal reconstruction for oil recovery, calibration for satellite remote sensing signal, high quality telecommunications signals for planning optimal networks and microwave towers, or for image reconstruction for historical pictures and films, there is a computer implemented method for improving a reconstruction model, comprising the steps of: (i) computing, with a processor, a plurality of empirical orthogonal functions (EOFs) by expanding set of observed historical imaging or signal processing gridded data into a finite series of the empirical orthogonal functions; (ii) displaying on a graphical user interface a covariance matrix of the observed historical imaging or signal processing gridded data set, eigenvalues of the observed historical imaging or signal processing gridded data set sorted from largest to smallest, and corresponding EOF vectors from the observed historical imaging or signal processing gridded data set; (iii) performing multivariate regression on the EOFs using the processor to determine weight coefficients of the EOFs; (iv) screening each of the plurality of EOFs and eliminating any EOF not supported by the first data set of observed historical imaging or signal processing gridded data; (v) generating a reconstruction model from the screened, weighted EOFs according to the following Reconstruction Model formula provided herein and, (vi) applying a multivariate regression error analysis to the reconstruction model to obtain a truncated sampling error variance from sampling the first N EOFs where N is between 10 and 30, wherein the reconstruction model is improved when combined with the truncated sampling error variance.

Example—Data Mining Model

In this example for recovering historical data mining data of various models for improving evaluating the effectiveness of advertising and marketing through social media, or for drug discovery using data mining method, there is a computer implemented method for improving a reconstruction model, comprising the steps of: (i) computing, with a processor, a plurality of empirical orthogonal functions (EOFs) by expanding set of observed historical data mining gridded data into a finite series of the empirical orthogonal functions; (ii) displaying on a graphical user interface a covariance matrix of the observed historical data mining gridded data set, eigenvalues of the observed historical data mining gridded data set sorted from largest to smallest, and corresponding EOF vectors from the observed historical data mining gridded data set; (iii) performing multivariate regression on the EOFs using the processor to determine weight coefficients of the EOFs; (iv) screening each of the plurality of EOFs and eliminating any EOF not supported by the first data set of observed historical data mining gridded data; (v) generating a reconstruction model from the screened, weighted EOFs according to the following Reconstruction Model formula provided herein and, (vi) applying a multivariate regression error analysis to the reconstruction model to obtain a truncated sampling error variance from sampling the first N EOFs where N is between 10 and 30, wherein the reconstruction model is improved when combined with the truncated sampling error variance.

Incorporation and Equivalents

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable Equivalents.

1. A computer implemented method for improving a reconstruction model, comprising the steps of:
(i) computing, with a processor, a plurality of empirical orthogonal functions (EOFs) by expanding set of observed historical gridded data into a finite series of the empirical orthogonal functions;
(ii) displaying on a graphical user interface a covariance matrix of the observed historical gridded data set, eigenvalues of the observed historical gridded data set sorted from largest to smallest, and corresponding EOF vectors from the observed historical gridded data set;
(iii) performing multivariate regression on the EOFs using the processor to determine weight coefficients of the EOFs;
(iii) screening each of the plurality of EOFs and eliminating any EOF not supported by the first data set of observed historical gridded data;
(iv) generating a reconstruction model from the screened, weighted EOFs according to the following formula:
R(x, t)=\hat{R}(x, t)+e(x, t), (1)
where
$$\hat{R} ( x , t ) = {\sum }_{m ∈ ℳ} {β}_{m} ( t ) {ψ}_{m} ( x ) = {\sum }_{m ∈ ℳ} {β}_{m} ( t ) {E}_{m} ( x ) / \sqrt{a ( x )} \qquad ( 2 )$$
wherein x denotes a first parameter of the gridded data on a grid having N boxes and hence x runs from 1 to N;
wherein a(x)=cos(φₓ) is a relative factor and is equal to the cosine of a second parameter related to the first parameter x;
wherein M is the set of selected EOF modes and has an order M;
wherein Eₘ(x) denotes the mth EOF computed from a weighted covariance matrix of the observed historical gridded data and the Euclidean norm of Eₘ(x) is one;
wherein ψₘ(x)=Eₘ(x)/\sqrt{a(x)} is an eigenfunction of an integral operator from a kernel of the unweighted covariance function;
wherein t denotes time;
wherein βₘ(t) is an estimated EOF weight or regression coefficient for the mth EOF;
wherein R(x, t) is the reconstruction model; and,
(v) applying a multivariate regression error analysis to the reconstruction model to obtain a truncated sampling error variance from sampling the first N EOFs where N is between 10 and 30, wherein the reconstruction model is improved when combined with the truncated sampling error variance.

2. The computer implemented method of claim 1, wherein the unknown parameter is precipitation and the known parameter is for geographic location.

3. The computer implemented method of claim 1, wherein the reconstruction model is a model of global precipitation changes on an annual basis.

4. The computer implemented method of claim 1, wherein the reconstruction model is a model selected from the group consisting of: a meteorological model for recovering the historical weather; a radiological imaging model for improving medical imaging; a virtual reality climate model of a gaming environment; a seismic signal reconstruction model for oil recovery processes; a calibration model for satellite remote sensing signals; a model of chemical processes for producing industrial chemicals; a model of bioreactor processes for producing biologics; a model for analyzing telecommunications signals; a model for tracking social media data for advertising and marketing purposes; and a microclimate model for controlling an HVAC system; a model of environmental pollution assessment using limited monitoring stations; a model of image reconstruction for historical pictures and films; a model of big data applications for signal recovery; and a model of drug discovery using data mining method.

5. The computer implemented method of claim 4, wherein the meteorological model for recovering historical data comprises climate parameters selected from the group consisting of temperature, precipitation, ocean salinity, atmospheric pressure, atmospheric humidity, and wind speed.

6. The computer implemented method of claim 4, wherein the model of for analyzing telecommunication signals further comprises the step of site-planning network and microwave towers.

7. A computerized system for utilizing an improved reconstruction model, comprising:
a computer having a processor, a memory, an input device, an output device, a computer bus, a power supply, an operating system and device-executable instructions for performing the methods of claim 1; and
a reconstruction model made according to the steps of claim 1 stored in the memory;

8. A computer-readable media storing a computer program on one or more device memories, the computer program comprising device-executable instructions for performing the method of claim 1.

9. A computer implemented method of improving reconstruction of a dataset having sampling errors made according to the steps of claim 1, further comprising the additional steps of: (v) using a computer processor to apply the improved reconstruction model to the dataset having sampling errors; (vi) obtaining an improved reconstructed dataset having fewer sampling errors than before the application of the reconstruction model; and (vii) saving the improved reconstructed dataset to a computer memory.

10. The computer implemented method of claim 9, wherein the dataset having sampling errors is selected from the group consisting of: a meteorological historical weather dataset; a radiological imaging dataset; a virtual reality gaming climate environment dataset; a seismic signal oil recovery dataset; a satellite calibration dataset; a chemical process dataset for producing industrial chemicals; a bioreactor process dataset for producing biologics; a telecommunications signal dataset; a social media advertising and marketing dataset; and a microclimate dataset for controlling an HVAC system; an environmental pollution assessment dataset; an image reconstruction dataset for historical pictures and films; and a drug discovery dataset.
